(19) United States
(12) Patent Application Publication
(10) Pub. No.: US 2007/0265917 A1
(43) Pub. Date: Nov. 15, 2007

(54) System and method for targeting print advertisements

(75) Inventors: Roger Robert Belanger, Dover, NH (US); Thomas Bowen Clarke, Durham, NH (US)

Correspondence Address: DAVIDSON, DAVIDSON & KAPPEL, LLC, 485 SEVENTH AVENUE, 14TH FLOOR, NEW YORK, NY, 10018, US

(73) Assignee: Goss International Americas, Inc., Dover, NH (US)

(21) Appl. No.: 11/702,322

(22) Filed: Feb. 5, 2007

Related U.S. Application Data
(63) Continuation-in-part of application No. 11/430,659, filed on May 9, 2006.

(51) Int. Cl. G06Q 30/00

(52) U.S. Cl. 705/14

(57) ABSTRACT

A method for targeting print advertisements includes: printing first advertising data with a first advertisement by a first print advertiser, the first advertising data identifying the first advertisement, the first advertising data capable of being scanned by a handheld device of a plurality of potential customers; providing the potential customers with a first incentive to scan the first advertising data; receiving the first advertising data scanned by a first plurality of the potential customers at a central server, each received first advertising data being received together with an identification of one of the plurality of handheld customers; and creating a second advertisement by the first print advertiser and delivering the second advertisement to the first plurality of the potential customers as a function of the received first advertising data and identifications.

### CROSS-REFERENCE TO RELATED APPLICATIONS

This is a continuation-in-part of U.S. Ser. No. 11/430,659, filed May 9, 2006 and hereby incorporated be reference herein.

### BACKGROUND

The present invention relates generally to printed materials with advertising.

U.S. Pat. Nos. 6,448,979 and 6,753,883, both hereby incorporated by reference herein, describe printed medium activated interactive communication of multimedia information, including advertising. A scanner and a receiver, which may be a single device, communicate with a portal server to play multimedia sequence information received from the portal server. Advertisements may be printed with a machine readable code such as a barcode including a high density bar code and the data from the code may be read by the scanner. The code contains link information corresponding to provider information and may be an alphanumeric sequence. The sequence may activate and result in the playing of multimedia sequence information. The scanner the receiver or the portal server can translate the link information into a network address, so that the multimedia sequence information can be played. Additionally or in the alternative, the network address information can point to a file containing executable computer code and displayed on the receiver or scanner. The system contemplates using additional code types such as benefit redemption information, rebate information and coupon information. The system may also collect and manage code that lacks link information, such as a UPC code. The person can take the UPC information home and get information on the product, a coupon, or other benefit redemption information.

User input information may be stored in the scanner memory. A communications bridge can send the link information and the user input information to the receiver and via a network to the portal server. The system also is capable of allowing print advertisers to track their impressions to execution and to collect demographic information about the person performing the scan through a tracking module. The tracking module is further capable of tracking the transaction value of e-commerce transactions originating from a specific publication, type of publication, or provider and calculate fee percentages based on the transaction. The scanner may have clock which can track the time the ad was scanned.

U.S. Pat. No. 6,896,182 is also incorporated by reference herein and describes a card verification system in which a card identification code is registered. A read unit reads the card identification code from the card. A verification apparatus verifies the card only when an existing place of the read unit belongs to an area corresponding to the card identification code. The card is a card used for settlement, and is used when the card identification code is read by the read unit. The use place of the card is coincident with the existing place of the read unit. By adding the use place of the card to a verification condition of the card, unjust use of the card can be prevented. This patent also describes a mobile remote operation point-of-sale terminal as disclosed in Japanese Laid Open Patent Application (JP-A-Heisei 11-500550). In an accounting system, a portable radio accounting terminal is provided in which a user inputs transaction data of dealings using keypad, a UPC bar code of the goods is read by a CCD sensor, a credit card, a debit card and a smart card of the user can be read. The portable radio accounting terminal transmits the dealings and card data to a central network controller via a radio communication network. The central network controller transmits to the host computer in the accounting facilities which processes the card data and the dealings in real time in order. The accounting facilities sends back confirmation data to the central network controller and send back to the radio accounting terminal via the radio communication network. Thus, the radio accounting terminal issues the printed receipt of the dealings to the user.

Targeting of print advertisements using certain information is known. For example, with zoning, different magazines can be formed with different advertisements. A magazine with an advertisement for a luxury automobile can be sent to magazines destined for a certain zip code, for example, while a similar magazine with an advertisement for a less expensive automobile can be sent to magazines destined for a different zip code.

The use of different phone numbers or coupon codes for certain advertisements such as coupons are also known. For example, a certain coupon code can be sent to one zip code, and the response rate for that zip code identified.

### SUMMARY OF THE INVENTION

The present invention provides a method for targeting print advertisements comprising:

printing first advertising data with a first advertisement by a first print advertiser, the first advertising data identifying the first advertisement, the first advertising data capable of being scanned by a handheld device of a plurality of potential customers;

providing the potential customers with a first incentive to scan the first advertising data;

receiving the first advertising data scanned by a first plurality of the potential customers at a central server, each received first advertising data being received together with an identification of one of the plurality of handheld customers; and

creating a second advertisement by the first print advertiser and delivering the second advertisement to the first plurality of the potential customers as a function of the received first advertising data and identifications.

The present invention also provides a system for providing targeted print advertisements comprising:

a central server receiving information related to scanned advertising data of a print advertiser from a plurality of handheld devices, the central server storing information on the scanned advertising data together with an identification in a searchable database.

The present invention also provides a method for providing advertisers with feedback comprising:

providing to a first print advertiser first advertising data to be printed with a first advertisement, the first advertising data identifying the first advertisement, the first advertising data capable of being scanned by handheld devices of a plurality of potential customers;

providing the potential customers with a first incentive to scan the first advertising data;

receiving the first advertising data scanned by responding potential customers at a central server together with an identification for each responding potential customer; and

providing to the first print advertiser information as a function of the identifications of each responding potential customer.

### BRIEF DESCRIPTION OF THE DRAWINGS

The present invention will be described further with respect to the drawings in which:

FIG. 1 shows a schematic of one embodiment of a system of the present invention;

FIG. 2 shows a flowchart for the feedback system of the present invention;

FIG. 3 shows a first graphical user interface screen for creating a promotion related a print advertisement; and

FIG. 4 shows a second graphical user interface screen on a handheld device.

### DETAILED DESCRIPTION

The present invention advantageously provides that print advertisers can obtain information and target advertisements based on actual feedback, and can have specific information related to advertisement effectiveness for individuals or identifications associated with handheld devices of individuals. Further advertisements then can be sent directly to those individuals or groups of individuals based on this specific information.

The present invention is particularly effective when used in combination with post-press equipment such as inserters, saddle stitchers or perfect binders. Individual hoppers can be activated as a function of the information to form printed products directly targeted to individuals.

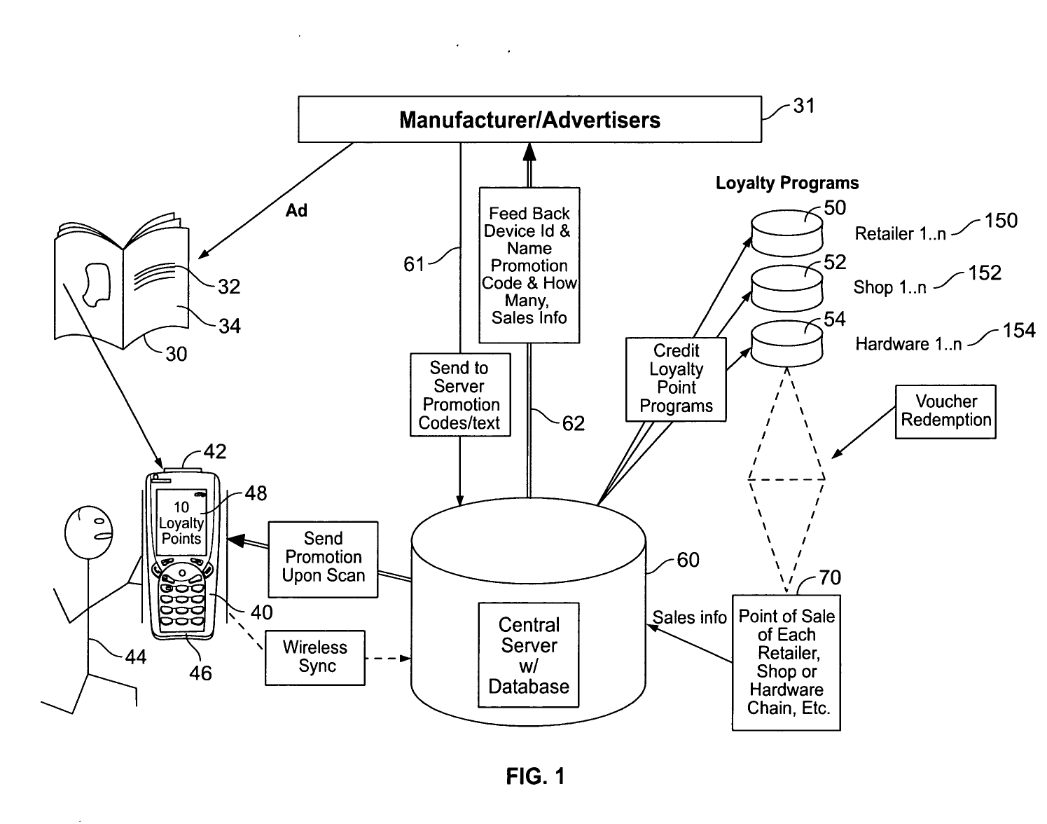

FIG. 1 shows a general overview of one embodiment of the present invention. An advertisement 32 from an advertiser 31 is printed for example in a magazine 30. Advertising data 34, such as the magazine name, page and advertiser identification information can be provided, for example in a code form as described in incorporated by reference U.S. Pat. No. 6,448,979. A potential customer 44 has a handheld device 40 for example an IPOD from Apple, or cell phone, the handheld device having a scanner 42 capable of scanning the printed advertising data 34 and inputting the advertising data into a memory of the handheld device 40. The scanner 42 may be a part of the device or detachable, and may include a camera held still.

Each scanned advertising data 34 can provide the potential customer 44 with an incentive, for example an increase in loyalty points for a specific loyalty points program 50 of the potential customer for the specific print advertiser or an electronic coupon. For example, the scanned advertisement may be for a local retailer 150 which advertises that the scan will provide an extra 50 points for the retailer's loyalty program. The customer 44 can then link to a home computer or other device, for example via a USB link or infrared link. The customer can then access for example a central server 60 which manages a plurality of loyalty point programs 50, 52, 54 for various advertisers 150, 152, 154. The user may for example mouse click on a window button so that the scanned advertisement data stored on the handheld device related to the local retailer is downloaded to a loyalty point collection server 60. The retailer 150 can provide the central server with promotion codes for the advertisements via link 61. When the scanned advertising data is received, the customer's account, via linking with a device ID for the handheld device, can then be credited and the advertising data and promotion code sent to the retailer 150, as shown by link 62. The retailer 150 thus knows that a particular handheld device read and scanned a particular advertisement, for example a local magazine advertisement shown on Jun. 6, 2006 on page 5. Information beneficial to the retailer, for example on types of publications a particular loyalty account holder reads and the response rates for advertisements can then be accumulated. This information can be tied into already known data such a purchase patterns of the account holders, and analyzed for improving advertising effectiveness.

In the embodiment described above, a click on the website will start a search of the database of the handheld device for advertising data related to the retailer 150. For example, the advertising data for a particular retailer could start with a unique 5 digit code and any advertising data for that particular retailer is then downloaded to the server 60. The data can then be erased from the handheld device. The loyalty point collection server 60 and/or handheld device 40 may provide duplicative scanning prevention can then ensure that the potential customer does not receive loyalty points for the same add scanned twice.

As opposed to the mouse click embodiment, the advertising data also may be sent to the server 60 from the handheld device 40 so that for example the customer 44 can scroll via an input device 46 on the handheld device 40 through the stored advertising data, for example via display information shown on a display 48. The display information is a function of the advertising data, and additional information may be obtained for example through interface of the handheld device with a server having display information. For example, the name of the retailer may appear for a particular stored advertising data and the customer then can push a button on an input device 46 of the handheld device 40 to send the advertising data to the server 60.

The server 60 can then validate and accept the sent advertising data. In this embodiment, the server can have duplication prevention so that a single ad from one customer can only be accepted once. The user or handheld device can erase the advertising data, since the user knows that the same data will not be accepted again. The sent data may include actual scanned data as well as additional data such as a time when the advertisement was read. The server then can credit the proper loyalty point program, here program 50 of retailer 150, for that user.

Advertisers 31 (including retailer 150, shop owner 152 or hardware store 154) can then determine the effectiveness of the advertisement 32, for example by monitoring scan rates for different publications. The advertiser can also determine the effectiveness of the incentive information associate therewith. For example, the retailer 150 can print 10,000 ads stating that a scan will be worth 10 loyalty points, and 10,000 ads stating that a scan will be worth 20 loyalty points, and provide advertising data indicating which of the ads are worth 10 points and which are worth 20 points. The advertiser can then see if the value change alters the response rate to the ads.

The advertiser 31 also can track redemption of the loyalty points, for example at the point of sale 70.

A printing press manufacturer for magazines or newspapers also could manage the loyalty point collection server 60 and store information on all the advertising data. For example, GOSS INTERNATIONAL CORPORATION could manage the server 60 and provide information to the advertisers 31 and also manage interaction with a plurality of loyalty points programs 50, 52, 54 of the customer 44. The collection server 60 thus, in addition to providing for setting up loyalty point programs for individual advertisers, can also provide a central point for the customer to manage all of the customer's loyalty points programs and require a single password access, and may for example have a single website, such as www.mygossspot.com. When the customer scans the advertisements, and then access the central website and click a mouse, the advertising data from the handheld device would be downloaded and loyalty points for the specific advertisements would be assigned to the loyalty programs 50, 52, 54. Each program account can be viewed on the user's account at the central website, as the advertisers participating in the advertising program are cooperating with the loyalty point collection server manager.

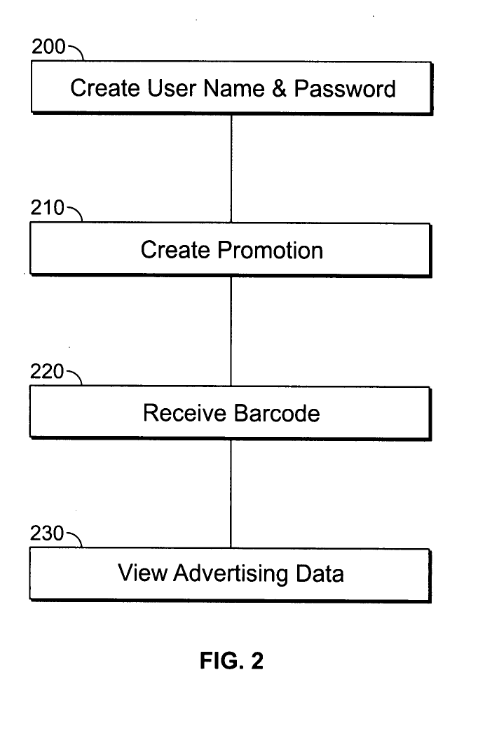

FIG. 2 shows a flow chart for a preferred embodiment for an advertiser 31, for example, retailer 150, shop 152 or hardware store 154, to increase the effectiveness of its print advertisements. A potential advertiser can log onto a central website, for example called www.mygossspot.com, by creating a user name and password in a first step 200. At step 210, the advertiser 31 can create a promotion for a particular print advertisement 32, for example offering 10 loyalty points in its loyalty point program and entering an identification for the advertisement 32, for example NEWSDAY Sep. 10, 2006 VERSION 1. Advantageously, the web page for creating the promotion may provide for a tiered promotion using opt-in levels, for example offering 10 loyalty points if a reader scans the advertisement and sends the scanned data in to server 60 with a device ID, 20 points if the reader scans the advertisement and sends the scanned data in to the server 60 with a device ID and an e-mail address, and 30 points if the reader scans the advertisement and sends in the scanned data to the server 60 with the device ID, an e-mail address and an answer to a survey question.

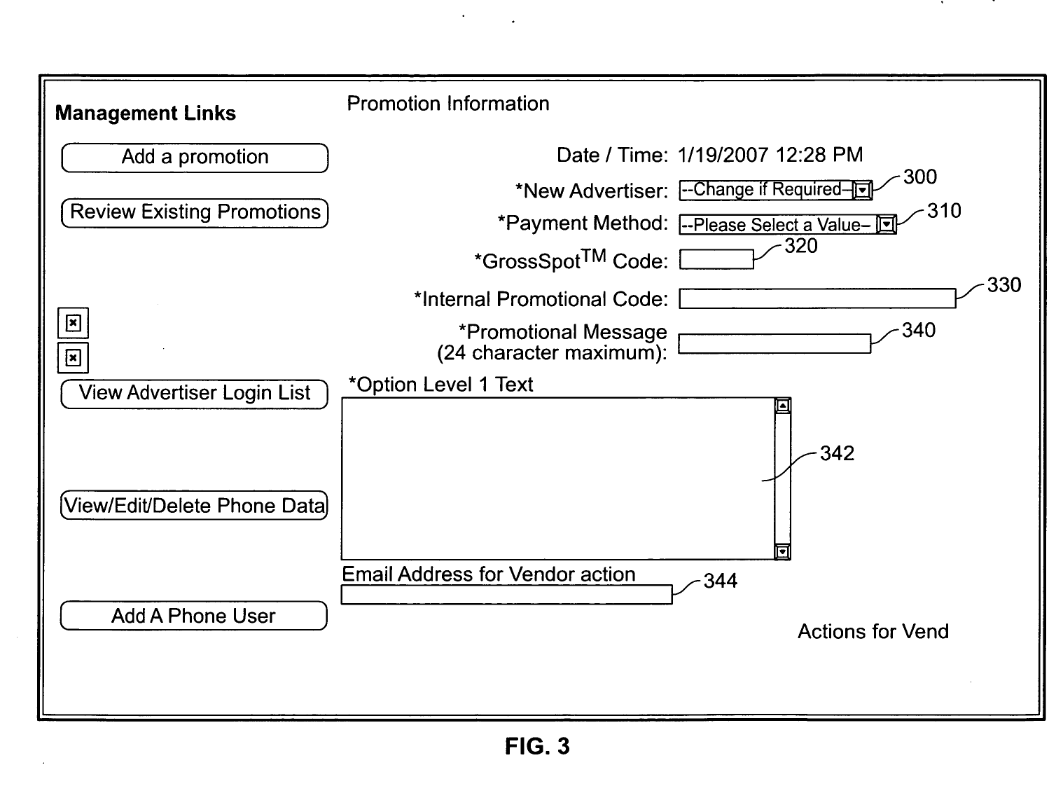

FIG. 3 shows an example of a graphical user interface for creating promotions for print advertisement 32. A print advertiser 300, for example known by a user ID and password, can select a payment method in block 310, for example a credit card on file. The advertiser has been given a code number for the scannable data to be associated with the print advertisement, which can be entered in block 320. An advertiser internal promotion code can also be entered in block 330. The advertiser can enter in a promotional message text in block 340. This text will be sent to the handheld device of a reader who scans the scannable data associated with the print advertisement, for example “YOU GOT 10 POINTS”. Advantageously, various further opt-in text messages can be sent, for example “Enter your e-mail address and get 10 extra points” by entering in the text in block 342. An e-mail address for an action associated with the opt-in response, can be entered in block 344, so that when the reader enters in a response to the text in block 342, the response and identifying information is sent to that vendors e-mail address for fulfillment. The advertiser can then fulfill the promotions, sort and store the data in a database, and analyze for further use. More than one opt-in level text blocks and associated e-mail address blocks may be provided.

Each device 40 may for example have a software client, which, when the advertising data 34 is scanned, queries the customer 44 if they would like to send in the data to receive the promotion, and can have a preset number of options related to the opt-in blocks, such as send in the data with device ID, with device ID and e-mail, or with device ID, e-mail and a query response. This software client can be downloaded from the server 60 to device 40. The loyalty points accounts for individuals in the various programs 50, 52, 54 can be created each time data is sent in, so that for example when a customer 44 scans an ad from retailer 50 and sends in the scanned data 34, the server 60 checks to see if the user ID matches any existing accounts in the loyalty points program 50, and if not, creates a new account based on the device ID. The accounts could be created separately also, for example, upon download of the software client by a customer 44.

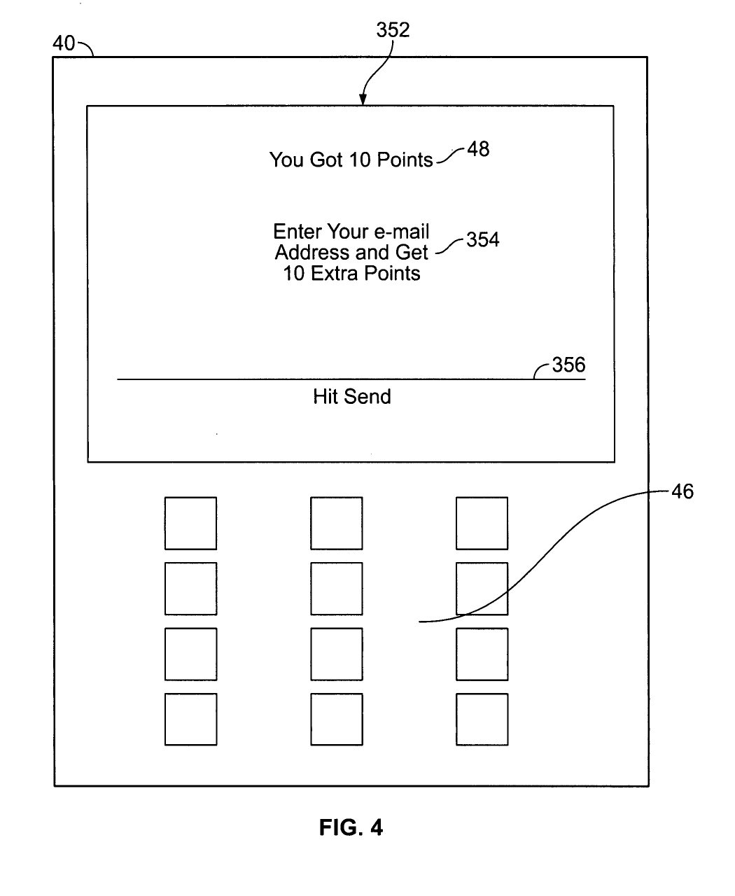

FIG. 4 shows a GUI or display 48 of the handheld device 40 with the promotional message 352 showing up on the GUI, as well as the optin level 1 text 354. A cursor or data entry field at 356 can be used by the user to enter in the response.

In a step 220, the advertiser 31 can enter in and receive for example a 2-D barcode 34 for the particular NEWSDAY advertisement 32 and the promotion. This barcode 34 image is then added for example in the pre-press process to a printing plate containing the advertisement 32.

At a step 230, the advertiser 150 then can view on a web-page data corresponding to the advertisement 32 and other advertisements. For example, the advertiser 150 can know that 700 NEWSDAY VERSION 1 advertisements were scanned, and that 6000 NEWSDAY VERSION 2 advertisements were scanned. The data can be arranged by date, device IDs, etc. If information on the users of the devices are stored or provided, zip code, demographic or income information for example can be associated and analyzed as well. In addition, at a point of sale 70 the advertisers 150, 152, 154 can track actual redemption of the promotions at the individual loyalty account level or coupon. The advertising effectiveness on sales, and not just on reading and scanning of the advertisements, can be tracked.

In particular, information can be stored for each device ID, so that for example it can be determined that device ID 187456 has scanned 10 different advertisements related to a certain product, for example, a luxury automobile, known from the advertisement codes. Also, device ID 18777 has scanned 8 different advertisements for the same luxury automobile, while device ID 18778 has scanned none.

This information can then be used to send a further advertisement, such as a direct mailing or coupon or e-mail. The advertiser can be given a query mechanism for the database, for example an SQL-based web page, to identify all device Ids where the number of advertisements for the particular product, here a luxury automobile, exceed for example 3. In step 210, a second advertisement then can be sent to only these device IDs, for example by a message via the handheld device. If more information, such as e-mail, address, or magazine subscription information is known, the second advertisements may be sent in this manner too.

The advertiser using the database can use more than one variable for a query, for example, identifying every device ID which has scanned both a luxury automobile advertisement and an expensive watch advertisement and has zip code information associated with the device ID, and then sending out a further advertisement such as a coupon or other promotion for an expensive restaurant in or near the zip code.

Actual purchase information, and additional information may be accumulated in the device ID database, for example e-commerce transactions known from an e-mail associated with the device ID, or actual sales using coupons sent to the device ID. Magazines and inserts can be delivered using the database information if subscription information is known so as to provide more targeted advertising in these media as well.

By providing a database and information on individuals viewing of print advertisements, and associating that viewing with a device ID, more effective and targeted advertisements can be produced.

Scanner as defined herein can include a camera, and scanning need not require movement of the handheld device.

What is claimed is:

1. A method for targeting print advertisements comprising:
printing first advertising data with a first advertisement by a first print advertiser, the first advertising data identifying the first advertisement, the first advertising data capable of being scanned by a handheld device of a plurality of potential customers;
providing the potential customers with a first incentive to scan the first advertising data;
receiving the first advertising data scanned by a first plurality of the potential customers at a central server, each received first advertising data being received together with an identification of one of the plurality of handheld customers; and
creating a second advertisement by the first print advertiser and delivering the second advertisement to the first plurality of the potential customers as a function of the received first advertising data and identifications.

2. The method as recited in claim 1 wherein the second advertisement is one of a coupon delivered to the handheld device, an e-mail, or a print advertisement.

3. The method as recited in claim 1 wherein the first advertisement is a printed advertisement.

4. The method as recited in claim 1 further comprising creating a database of the identifications and the first advertising data.

5. A system for providing targeted print advertisements comprising:
a central server receiving information related to scanned advertising data of a print advertiser from a plurality of handheld devices, the central server storing information on the scanned advertising data together with an identification in a searchable database.

6. The system as recited in claim 5 further comprising a graphical user interface for the print advertiser, the graphical user interface being provided by the central server, and having fields to enter in text related to a promotion offered for scanning the scanned advertising data.

7. The system as recited in claim 6 further comprising a software client for the handheld devices permitting the text related to the promotion to be shown on the handheld device, the software client being downloadable by a handheld device from the central server.

8. The method as recited in claim 1 further comprising creating a set of third printed advertisements as a function of the received first advertising data to increase advertising effectiveness.

9. The method as recited in claim 8 further comprising creating further sets of printed advertisements to further increase advertising effectiveness.

10. The method as recited in claim 1 further comprising combining additional sources of data on specific customers with the first advertising data to further improve the targeting methods.

11. A method for providing advertisers with feedback comprising:
providing to a first print advertiser first advertising data to be printed with a first advertisement, the first advertising data identifying the first advertisement, the first advertising data capable of being scanned by handheld devices of a plurality of potential customers;
providing the potential customers with a first incentive to scan the first advertising data;
receiving the first advertising data scanned by responding potential customers at a central server together with an identification for each responding potential customer; and
providing to the first print advertiser information as a function of the identifications of each responding potential customer.
